(19) United States
(12) Patent Application Publication
(10) Pub. No.: US 2013/0004633 A1
(43) Pub. Date: Jan. 3, 2013

(54) EFFICIENCY FOOD SMOKER

(75) Inventors: Robert Allen McMaster, Wexford, PA (US); Craig William Elving, Effingham, IL (US); Leonard Scott Huff, Shenzhen (CN)

(73) Assignee: LINK FORGE LIMITED, Wexford, PA (US)

(21) Appl. No.: 13/528,497

(22) Filed: Jun. 20, 2012

Related U.S. Application Data
(60) Provisional application No. 61/502,854, filed on Jun. 29, 2011.

(51) Int. Cl. A23B 4/052

(52) U.S. Cl. 426/314; 99/482

(57) ABSTRACT

Food smoker with self-basting features and relatively low thermal conductivity chip bowls. A lid of the food smoker may include downward pointing protrusions to control dripping onto food being smoked. This self-basting feature reduces the need to open the food smoker to baste the food smoking. The food smoker may include a ceramic chip bowl to reduce the rate of consumption of wood chips used to add flavoring to the food being smoked. This further reduces the need to open the food smoker. The housing of the smoker may be constructed with inner and outer walls, minimizing the heat loss during the cooking process. In combination, these features result in an improved food smoker that requires less user interaction than traditional systems. Moreover, the food smoker may need to be opened fewer times during the smoking process, which reduces heat loss and thus leads to greater energy efficiency.

### RELATED APPLICATIONS

This application claims priority from U.S. Provisional Patent Application No. 61/502,854, filed Jun. 29, 2011, entitled “Improved Efficiency Food Smoker,” the entire disclosure of which is incorporated by reference herein.

### FIELD OF THE INVENTION

The present invention relates to an improved food smoker in general, and in particular, an improved efficiency food smoker comprising a self-basting feature, and a ceramic chip bowl.

### BACKGROUND OF THE INVENTION

Food smokers are used for smoking food in a single unit. A flavoring source, such as charcoal briquettes with flavoring wood chips, wood chips and/or wood chunks are burned at the bottom of the food smoker to smoke food on racks supported above the flavoring source.

Current food smokers typically utilize metal materials, typically either cast iron, or porcelain coated steel, for holding the flavoring source that creates the smoke and adds flavor to the food in the smoker. Current food smoker designs require that the user open the food compartment during the cooking process in order to baste the food to add flavor and avoid the food becoming too dry. Current food smoker designs also require that the user open the smoker during the smoking process in order to add additional flavoring source.

### SUMMARY OF THE INVENTION

Embodiments of the present invention are directed toward a food smoker with self-basting features and relatively low thermal conductivity chip bowls. A lid of the food smoker may include downward pointing protrusions to control dripping onto food being smoked. This self-basting feature reduces the need to open the food smoker to baste the food smoking therein. The food smoker may include a ceramic chip bowl to reduce the rate of consumption of wood chips or other flavoring sources used to produce smoke to add flavoring to the food being smoked. The ceramic chip bowl may also result in more even heating of the chips placed therein as compared to typical metal chip bowls. Thus, the ceramic chip bowl may further reduce the need to open the food smoker. In combination, these features result in an improved food smoker that requires less user interaction than traditional systems. Moreover, the reduced interaction results in the food smoker needing to be opened fewer times during the smoking process, which decreases total smoking time and reduces heat loss associated with opening the food smoker and thus leads to greater energy efficiency.

In one aspect, a food smoker includes a housing comprising a base and a lid, a heat source, a ceramic chip bowl, and a first food rack. The housing may be vertically oriented. The lid is positioned on a top of the base. The heat source is disposed within the housing, and the ceramic chip bowl is disposed between the heat source and the lid. The ceramic chip bowl is disposed above the heat source and below the lid. The first food rack includes a cooking surface and is positioned between the ceramic chip bowl and the lid. The lid includes a perimeter and a region within the perimeter. The lid further includes a plurality of downward pointing protrusions positioned within the region within the perimeter and over the cooking surface. Each protrusion of the plurality of downward pointing protrusions is configured to provide a location for the concentration of condensate.

In an embodiment, the housing may be a double-wall thermally insulating housing. The lid may also be a double-wall thermally insulating lid. The double-wall construction, including the housing and/or lid, may limit undesired heat loss, allowing for the inside chamber to maintain a more even temperature, thereby reducing the amount of adjustment to the heat source required throughout the cooking process. The double-wall construction therefore may reduce the amount of adjustment to the heat source needed to maintain consistent temperature. The double-wall thermally insulating housing and/or the double-wall thermally insulating lid, may each include two walls, an inner and outer wall, with a gap between the two. This gap may be a void (e.g., filled with air) or the gap may be filled with any other appropriate insulating material. Additionally, regarding the two walls of the lid, the inner wall may contain the protrusions for self-basting and may be removable form the outer wall of the lid.

In an embodiment, each protrusion of the plurality of downward pointing protrusions may be formed integrally with the lid. The region within the perimeter of the lid may be substantially planar except for the plurality of downward pointing protrusions, and the plurality of downward pointing protrusions may be formed by deforming the lid in a downward direction from the region within the perimeter of the lid. The plurality of downward pointing protrusions may be arranged in successive diameter rings about a center of the lid.

In an embodiment, the food smoker may further include a water bowl disposed between the ceramic chip bowl and the first food rack. The food smoker may further include a diffuser disposed between the ceramic chip bowl and the water bowl, and a second food rack disposed between the first food rack and the lid.

The heat source for the food smoker may be a propane or natural gas burner.

In an arrangement, the lid may include a first portion and a second portion. The first portion may be generally planar, and the second portion may include the plurality of downward pointing protrusions. The first and second portions may be fastened to each other. In a variation, the first and second portions may be removably and replaceably fastened to each other, such that a user may choose whether or not to attach the second portion to the first portion when smoking food within the food smoker. In a variation, when fastened to each other, the first and second portions may have an insulating gap therebetween. The gap could be a void (e.g., filled with air) or the gap may be filled with any other appropriate insulating material. As discussed above, such a gap may limit undesired heat loss, allowing for the inside chamber to maintain a more even temperature, thereby reducing the amount of adjustment to the heat source required throughout the cooking process. In another variation, the first portion may be a double-wall thermally insulating portion as previously described, and the second portion may be removably and replaceably fastened to the first portion to allow the user to choose whether or not to have the protrusions present when smoking food within the food smoker.

In an embodiment, the ceramic chip bowl may include a bottom wall and a side wall forming an interior portion. The interior portion may be uncovered by any portion of the ceramic chip bowl. The walls of the ceramic chip bowl may be about 12 mm thick. The composition of the ceramic chip bowl may include silicon dioxide and aluminum oxide. In a variation, the composition of the ceramic chip bowl may include between 1.25 and 1.75 times more silicon dioxide than aluminum oxide. For example, the ceramic chip bowl may include between 50 and 60 percent silicon dioxide, and between 34 and 42 percent aluminum oxide.

In another aspect, a method of smoking food includes inserting wood chips into a ceramic chip bowl and positioning the ceramic chip bowl in a housing of a food smoker. The method also includes positioning food on a food rack within the housing above the ceramic chip bowl and placing a lid on top of the housing. Heat is produced within the housing, and this causes the wood chips to produce smoke. The method further includes condensing liquid on an underside of the lid of the smoker, and collecting the condensate at a lowermost portion of each protrusion of the plurality of protrusions. The collected condensate then drips from the plurality of protrusions onto the food. The method may further include, in any appropriate order, placing water in a water bowl and placing the water bowl within the housing. The method may further include burning propane to produce the heat.

Additional aspects and advantages of the present invention will become apparent to one skilled in the art upon consideration of the further description that follows. It should be understood that the detailed description and specific examples are intended for purposes of illustration only and are not intended to limit the scope of the invention. Furthermore, any of the above arrangements, features and/or embodiments may be combined with any of the above aspects where appropriate.

### BRIEF DESCRIPTION OF THE DRAWINGS

For a more complete understanding of the present invention and further advantages thereof, the following Detailed Description of the Invention is provided along with the following drawings.

FIG. 1 is an isometric illustration of a food smoker.

FIG. 2 is an exploded illustration of the food smoker of FIG. 1.

FIG. 3 is an illustration of a lid of the food smoker of FIG. 1.

FIG. 4 is an illustration of an alternate construction of the lid of FIG. 3.

### DETAILED DESCRIPTION OF THE INVENTION

In the following description, embodiments of the present invention are set forth in the context of food smokers with self-basting features and relatively low thermal conductivity chip bowls. In particular, a lid of the food smoker may include downward pointing protrusions to control dripping onto food being smoked. This self-basting feature reduces the need to open the smoker to baste the food being smoked therein. Additionally, the food smoker may include a ceramic chip bowl to reduce the rate of consumption of wood chips used to add flavoring to the food being smoked. This further reduces the need to open the food smoker. The housing of the smoker, including walls and lid, may be constructed with an inner and an outer wall. Such double-wall construction may minimize the heat loss during the cooking process. In combination, these features result in an improved food smoker that requires less user interaction than traditional systems. Moreover, the reduced interaction results in the food smoker needing to be opened fewer times during the smoking process, which reduces heat loss associated with opening the food smoker and thus leads to greater energy efficiency.

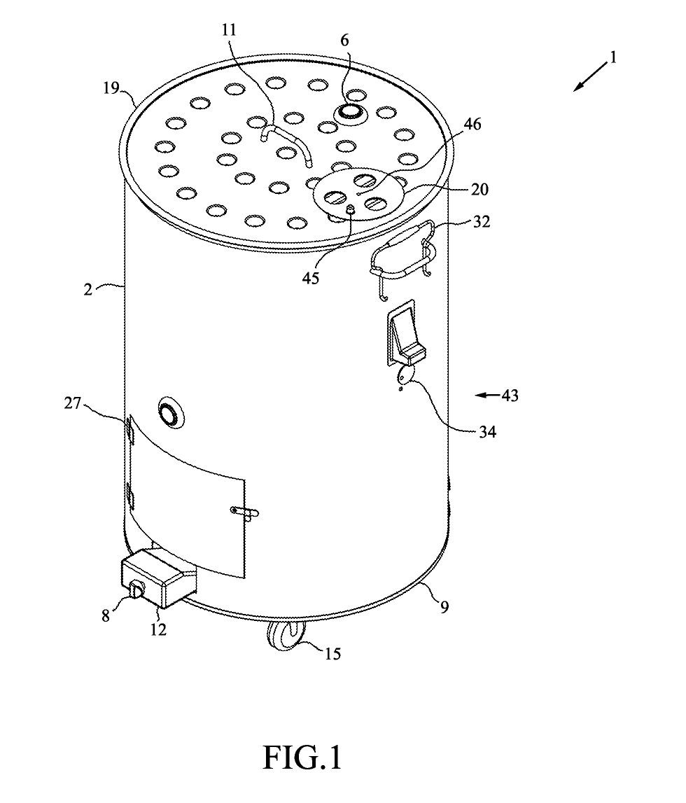

FIG. 1 illustrates a food smoker 1. The food smoker 1 includes a housing 43 in which food may be placed and smoked. The housing 43 may be vertically oriented. The housing 43 includes a lid 19, a side wall 2, and a base 9. In a variation, the housing 43 may be constructed with inner and outer side walls with a gap between the inner and outer side walls. The gap may be a void (e.g., containing air) or it may be filled with any appropriate insulating material.

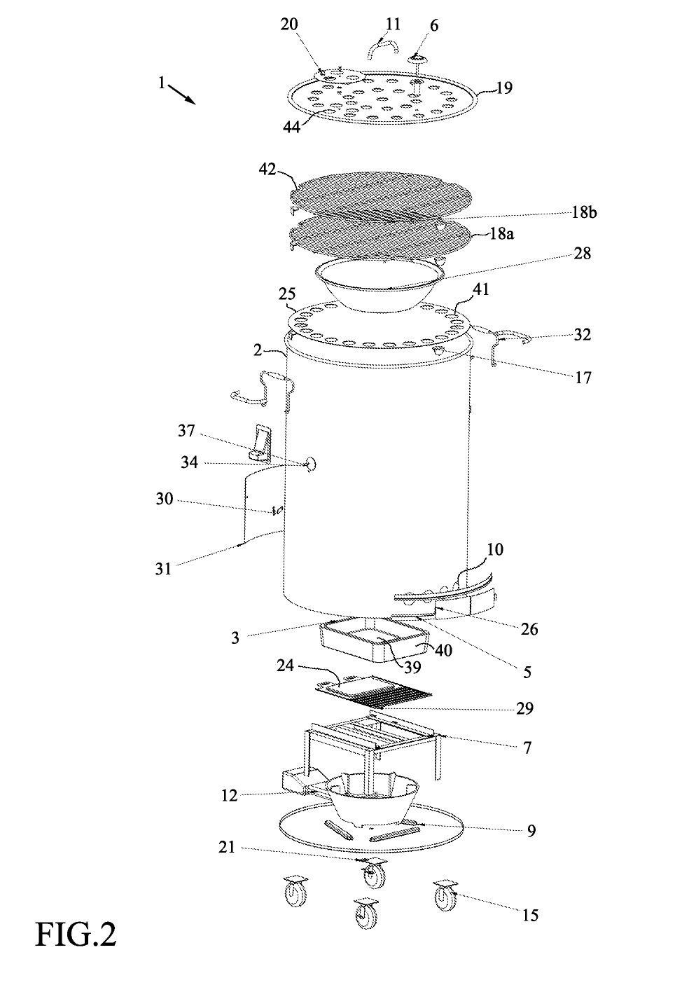

FIG. 2 is an exploded diagram of the food smoker 1 of FIG. 1 showing, inter alia, components typically disposed within the housing 43. Starting from the bottom of the housing 43, the food smoker 1 may include features to support the housing 43 such that the housing 43 is elevated when the food smoker 1 is placed on a flat surface. As illustrated, the support may include a set of casters 15 that would allow for the food smoker 1 to be easily moved along a flat surface. At least one of the casters 15 may include a brake mechanism to selectively reduce the ability of the food smoker 1 to be moved.

The casters 15 may be fastened to the underside of the base 9. The base 9 may, for example, be made form steel. The base 9 may have a through-hole to allow any liquids within the housing 43 to be drained therethrough. The through hole may be plugged with a plug 21 when the housing 43 is not being drained. The plug 21 may be made from silicone or any other appropriate material capable of withstanding the temperatures generated during smoking.

A heat source 12 may be disposed at the bottom of the inside of the housing 43. As illustrated, the heat source 12 may be a propane burner. The heat source 12 may be adjustable to control the temperature within the housing 43 during smoking. The adjustment may be performed via a user control such as knob 8 (FIG. 1). Where the heat source 12 is a propane burner, the heat source may be connected to a propane supply (not shown). Other types of heat sources that may be used include natural gas, wood, charcoal, electrical heating elements, or any other appropriate heat source for smoking or cooking food.

A frame 7 may provide a support for a drawer 29 such that the drawer is positioned over the heat source 12. The frame 7 may allow for the drawer 29 to slide from a position within the housing 43 and over the heat source 12 to a position at least partially outside of the housing 43. The drawer 29 may support a ceramic chip bowl 3. The ceramic chip bowl 3 may hold a flavoring source such as, for example, wood chips, wood chunks, wood sticks, and/or charcoal briquettes with flavoring sources embedded therein. The ceramic chip bowl 3 and drawer 29 may each be configured to mate with each other such that when the ceramic chip bowl 3 or drawer 29 is pulled the other of the ceramic chip bowl 3 or drawer 29 moves also. For example, the drawer 29 may include a rectangular protrusion 24 that may interface with a corresponding feature on the bottom of the ceramic chip bowl 3.

The drawer 29 may be accessible through the side wall 2 via a door 31. In a variation, the door 31 may be of double-wall construction similar to as described above for the side wall 2. In this regard, a user may open the door 31, pull on the drawer 29, which also correspondingly moves the ceramic chip bowl 3, to gain access to the ceramic chip bowl 3 to, for example, replenish the ceramic chip bowl 3 with additional flavoring source (e.g., wood chips). The door 31 may be attached to the side wall 2 via hinges 27 (FIG. 1) and be secured in a closed position via a latch 30.

The ceramic chip bowl 3 may be configured to hold the flavoring source over the heat source 12 during smoking. In this regard, the ceramic chip bowl 3 may include a bottom wall 39 and a side wall 40. The ceramic chip bowl 3 may be open to the top to allow smoke generated by the heating of the flavoring source therein to rise toward the food being smoked. The ceramic chip bowl 3 may comprise any appropriate ceramic material. For example, the ceramic chip bowl 3 may include silicon dioxide and aluminum oxide. The composition of the ceramic chip bowl 3 may include between 1.25 and 1.75 times more silicon dioxide than aluminum oxide. For example, the ceramic chip bowl 3 may contain between 50 and 60 percent silicon dioxide and 34 and 42 percent aluminum oxide. In an exemplary embodiment, the ceramic chip bowl 3 may be composed of about 55 percent silicon dioxide and 38 percent aluminum oxide. In another example, the ceramic chip bowl 3 may be terra cotta. The ceramic chip bowl 3 may be glazed or unglazed.

As compared to metal chip bowls present in prior art smokers, the ceramic chip bowl 3 may retard the heating of the flavoring source therein and heat the flavoring source more evenly. For example, the ceramic chip bowl 3 may result in the flavoring source burning at a rate from 25 to 50 percent slower than a metal chip bowl. Such reduction has multiple advantages. The slower burn rate results in less flavoring source consumption. The slower burn rate also reduces the frequency at which the flavoring source must be replenished. This results in less labor expended during the smoking process and less fuel used to heat the housing 43, since each time the door 31 is opened heat escapes which must be regenerated to maintain a desired temperature within the housing 43.

The side wall 2 may include openings 10 to allow air into the interior of the housing 43 in the vicinity of the heat source 12. An air shield 26 may be positionable over the openings 10 to restrict the flow of air through the openings 10. The air shield 26 may slide in a set of air shield rails 5 between a position where the air shield 26 restricts the flow of air through the openings 10 and a position where the air shield 26 does not restrict the flow of air through the openings 10.

The side wall 2 may also include an opening 37 through which may be inserted a temperature measurement device (not shown) or through which wires that are connected to a temperature measurement device may be routed. A cover 34 may be movable from a position covering the opening 37 to a position where a temperature probe may be inserted through the opening 37. The opening 37 may be situated at an elevation corresponding to where food being smoked within the housing 43 is positioned, thus a temperature measured through the opening 37 may coincide with the temperature at which the food is exposed.

The food smoker 1 may include handles 32 interconnected to the side wall 2 and capable of being used to lift the food smoker 1. The handles 32 may be insulated such that a user may be able to grasp the handles 32 despite the housing 43 being at an elevated temperature. For example, the handles 32 may be made from stainless steel coated with an insulating layer of a thermoplastic elastomer.

Within the housing 43, a diffuser plate 25 may be positioned above the ceramic chip bowl 3. The diffuser plate 25 may generally provide a barrier between the portion of the housing 43 where heat and smoke are generated and the portion of the housing 43 where the food being smoked resides. In this regard, the diffuser plate 25 may prevent direct exposure of the food being smoked to infrared heat generated by the heat source 12. The diffuser plate 25 may include a plurality of holes disposed toward the outside edges of the diffuser plate 25 to allow smoke from the flavoring source in the ceramic chip bowl 3 to rise up toward the food being smoked. The diffuser plate 25 may be held in place by support tabs 17 interconnected to the inside surface of the side wall 2.

A water bowl 28 may be positioned within the housing 43 and atop the diffuser plate 25. The water bowl 28 may provide a location for water to be held within the housing 43. Heat rising from the heat source 12 may heat the diffuser plate 25 and in turn heat the water bowl 28 causing water within the water bowl 28 to turn to water vapor. Such water vapor may maintain moisture within the food being smoked. Such water vapor may also condense on the underside of the lid 19 and subsequently drip onto the food being smoked as described below.

A first food rack 18a may be positioned above the water bowl 28 and supported along the periphery of the first food rack 18a in a first position by appropriately positioned additional support tabs 17 attached to the side wall 2. At least a portion of the food being smoked may be positioned on the first food rack 18a. A second food rack 18b may be positioned above the first food rack 18a and supported along the periphery of the second food rack 18b in a second position (above the first position) by appropriately positioned additional support tabs 17 attached to the side wall 2. At least a portion of the food being smoked may be positioned on the second food rack 18b. The first food rack 18a and second food rack 18b may be identically configured. The first food rack 18a may include recesses 42 along the periphery of the first food rack 18a operable to be aligned with support tabs 17 at the second position such that the first food rack 18a may be lifted past the support tabs 17 at the second position. For example, to remove the first food rack 18a from the housing 43, a user may first lift the first food rack 18a off of the support tabs 17 at the first position, as the first food rack 18a approaches the second position, the user may rotate the first food rack 18a such that the recesses 42 are aligned with the support tabs 17 at the second position. The user may next further lift the first food rack 18a such that the recesses 42 pass over the support tabs 17 at the second position. The user may then lift the first food rack 18a to remove the first food rack 18a from the housing 43. The first food rack 18a may be installed in the first position by reversing the removal process. Both the first food rack 18a and second food rack 18b may be in the form of wire racks comprising intersecting wires welded together to form cooking surfaces.

A pair of tools may be used to separately lift each of the first and second food racks 18a, 18b from the food smoker 1. Each of the tools may include a handle attached to an elongated member. At an end of the elongated member opposite the handle, the tool may include a member to interface with one of the first and second food racks 18a, 18b. For example, the member may be T-shaped such that it may be inserted between wires of the food rack and then turned 90 degrees such that when the tool is lifted, the member will engage the wires such that the food rack is also lifted. Other appropriate tools, such as tools that grasp one or more wires of the food rack may also be used.

The lid 19 may be removably and replaceably positioned at the top of the housing 43. The shape of the lid 19 may match the cross section of the side wall 2. For example, as illustrated, the side wall 2 may form a vertically oriented cylinder and the lid 19 may be round and of a corresponding diameter. In an alternative arrangement, the side wall 2 could form any appropriate cross section. For example, the side wall 2 could form a rectangular or square cross section, and the lid 19 may be in the shape of a corresponding rectangle or square, respectively.

A lid handle 11 may be interconnected to the lid 19 and may allow a user grasping the lid handle 11 to remove the lid from the housing 43 or replace the lid 19 onto the housing 43. The lid 19 may further include a vent 44 which may comprise one or more through holes in the lid 19. A vent cover 20 may allow the vent to be fully covered, partially covered, or fully uncovered. As illustrated in FIGS. 1-3, the vent 44 may be in the form of three through holes through the lid 19. The vent cover 20 may have three correspondingly sized and positioned through holes. Further, the vent cover 20 may be rotatably interconnected to the lid at a center point 46 relative to the vent 44. The vent cover 20 may further include a vent cover protrusion 45. A user may grasp the vent cover protrusion 45 and rotate the vent cover 20 about the center point 46 to partially or fully cover the vent 44 with the vent cover 20. Thus the size of the opening between the housing 43 and the external environment may be controlled.

A temperature indicating device 6 may be interconnected to the lid 19. The temperature indicating device 6 may be in the form of a thermometer with a sensing portion positioned below the underside of the lid 19 and an indicator portion positioned above the top surface of the lid 19. In this regard, a user may be able to read the indicator portion of the temperature indicating device 6 while the lid 19 is installed on the housing 43 and determine the temperature within the housing 43 at the sensing portion of the temperature indicating device 6.

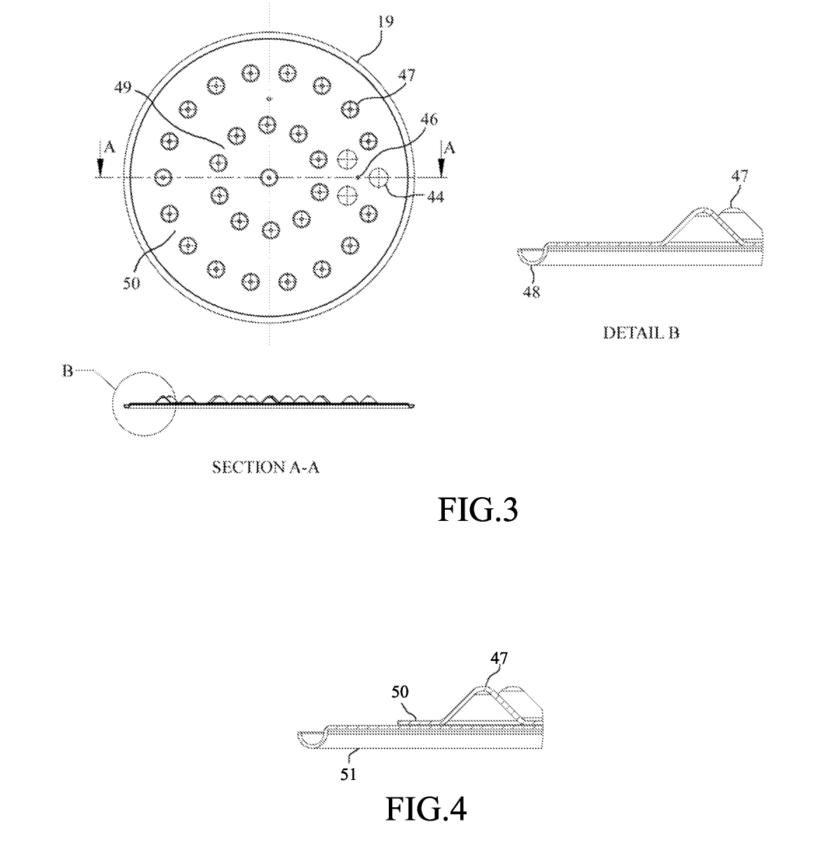

The lid 19 may include a plurality of downward pointing protrusions 47. Such downward pointing protrusions 47 are illustrated in FIG. 3 which illustrates the lid, a cross section A-A of the lid and a detailed illustration (detail B) of one of the downward pointing protrusions 47. The downward pointing protrusions 47 may control dripping onto the food being smoked. In this regard, water vapor from the water in the water bowl 28 may condense on the underside of the lid 19 to form condensate on the underside of the lid 19. This condensate may include various substances that have emanated from the food being smoked and constituents of the smoke from the flavoring source within the ceramic chip bowl 3. Portions of the condensate may then flow downward along the sides of the downward pointing protrusions 47 to the lowest points of the downward pointing protrusions 47. As the condensate accumulates, droplets of condensate will form and fall from the downward pointing protrusions 47 onto the food being smoked below. This process or self-basting (i.e., basting without active user participation) may add moisture and/or flavoring to the food being smoked. This self-basting is done without the need to open the lid 19 to the food smoker 1, thus conserving heat, reducing energy usage, reducing user labor, and reducing smoking time. Such self-basting may reduce the need to open the food smoker 1, which may reduce energy consumption by, for example, up to 10 to 20 percent.

The downward pointing protrusions 47 may be in the form of dimples or cones formed in the lid 19. The downward pointing protrusions 47 may be of any other appropriate form capable of concentrating condensate from a first area to a smaller second area from which the condensate may drip. For example, the downward pointing protrusions 47 may be pyramid shaped.

The lid 19 may further include a flange 48 that may fit over a top edge of the side wall 2 to assist in securing the lid 19 to the side wall 2 during smoking.

The downward pointing protrusions 47 may be arranged in any appropriate configuration or pattern to provide multiple condensation concentration points over the food being smoked. For example, as illustrated in FIG. 3, a first portion of the downward pointing protrusions 47 may be distributed in a first circular pattern 49 on the lid 19. The first circular pattern 49 may be centered about a center point of the lid 19 at a first distance from the center point of the lid 19. A second portion of the downward pointing protrusions 47 may be distributed in a second circular pattern 50 on the lid 19. The second circular pattern 50 may be centered about a center point of the lid 19 at a second distance from the center point of the lid 19. As illustrated, the first distance may be less than the second distance. Also, a downward pointing protrusion may be positioned at the center of the lid 19. In general, the lid may comprise a perimeter and a region within the perimeter where the downward pointing protrusions 47 may be appropriately arranged in the region within the perimeter of the lid 19.

As illustrated, the lid 19 comprises 28 downward pointing protrusions 47. In an embodiment, more or fewer downward pointing protrusions 47 may be present. For example, in a variation, a total of 12 or more downward pointing protrusions 47 may be present. Furthermore, the size of the downward pointing protrusions 47 may be varied such that they occupy a greater or lesser percentage of the area of the lid 19 than as illustrated.

As illustrated, the lid 19 is constructed from a single flat sheet with the downward pointing protrusions 47 formed therein. In a variation, the lid may be of double-wall construction with a gap between the walls similar to as discussed with reference to the side wall 2. In another variation illustrated in FIG. 4, the downward pointing protrusions 47 may be formed in a member 50 that is separate from a lid 51. FIG. 4 is a cross section of such a lid 51 and member 50 similarly situated as the cross section of Detail B of FIG. 3. In such an embodiment, the lid 51 may be free of the protrusions 47, and the separate member 50 may be removably and replaceably attached to the underside of the lid 51. Thus, a user may select whether or not to install the separate member 50 comprising the downward pointing protrusions 47 when beginning the process of smoking food within the food smoker 1. Such a separate member 50 may be attachable to the bottom side of the lid 51 in any appropriate manner. With such a separate member 50, the self-basting feature provided by the downward pointing protrusions 47 of the food smoker 1 may be optional for any particular smoking operation. Additionally, such a separate member 50 comprising the downward pointing protrusions 47 may be installed or removed as desired during a smoking operation, thus effectively turning on or off the self-basting function during the smoking process. In a first variant, a gap may be present between the lid 51 and the separate member 50 when interconnected, and this gap may provide an insulative effect similar to as described above with reference to double-wall construction. In a second variant, the lid 51 may include two walls, an inner and outer wall, with a gap between the two, and the separate member 50 may be attachable to the bottom side of such a double-walled lid 51 in any appropriate manner.

Exemplary dimensions of the embodiment of the food smoker 1 illustrated in FIGS. 1 and 2 will now be presented. Such dimensions are for exemplary purposes. The exemplary dimensions of the various components may be varied from these dimensions as appropriate. In an exemplary embodiment, the approximate overall height of the food smoker 1 may be about 945 millimeters (mm) and the diameter of the side wall may be about 570 mm. In an exemplary embodiment, the diameter of the water bowl 28 may be about 401 mm and the overall height may be about 100 mm. In an exemplary embodiment, the diameters of the diffuser plate 25, first food rack 18a, and second food rack 18b all may be about 565 mm. The plurality of holes 41 through the diffuser plate 25 may be arranged near the perimeter of the diffuser plate 25 and the diameter of each hole of the plurality of holes 41 may be about 40 mm. The diffuser plate 25 may include a total of about 24 such holes. In an exemplary embodiment, the ceramic chip bowl 3 may measure about 289 mm by 227 mm and may be about 63 mm in height. In an exemplary embodiment, the ceramic chip bowl 3 may have a wall thickness of about 12 mm. In an exemplary embodiment, each protrusion of the plurality of downward pointing protrusions 47 may extend about 15 mm from the bottom surface of the lid 19. In an exemplary embodiment, each protrusion of the plurality of downward pointing protrusions 47 may have a diameter at the bottom surface of the lid 19 of about 30 mm.

The side wall 2, base 9, and diffuser plate 25, may be made from steel or any other appropriate material or combination of materials, such as other types of metals (including stainless steel and/or cold rolled steel), coated metals or ceramics. The lid 19, first food rack 18a, second food rack 18b, water bowl 28, drawer 29, may be made from stainless steel or any other appropriate material or combination of materials, such as other types of metals (including non-stainless steel), coated metals or ceramics.

A method of smoking food will now be described. The method may use the food smoker 1. First steps of the method may include inserting wood chips and/or other flavoring sources into a ceramic chip bowl and inserting the ceramic chip bowl into the interior of a smoker. The method may further include positioning food to be smoked on one or more food racks positioned above the ceramic chip bowl within the smoker. After the food is positioned, a lid may be placed onto the smoker over the food. The food being smoked may include, for example, pork, beef, lamb, sausage, seafood, poultry and/or any other appropriate type of meat that may be smoked. Such meat may be in any appropriate form, including for example, chops, roasts, steaks, shredded, and/or ground. The food being smoked may include, for example, non-meats.

Heat may be produced within the smoker, causing the wood chips and/or other flavoring sources to produce smoke within the smoker, thus flavoring and smoking the food. The heat may be produced by burning propane within a lower portion of the smoker. The heat may also cause water disposed in a water bowl within the smoker to turn to steam. The production of heat may be controlled to produce, for example, a temperature of about 110° C. within the interior of the smoker. Such an interior temperature may be maintained for several hours (e.g., 10, 15 or more hours).

The method may further include condensing liquid on an underside of the lid and collecting, by gravity, the condensate at a lowermost portion of each protrusion of the plurality of protrusions. The method may further include dripping the collected condensation from the plurality of protrusions onto the food being smoked.

While various embodiments have been described in detail, it is apparent that further modifications and adaptations of the invention will occur to those skilled in the art. However, it is to be expressly understood that such modifications and adaptations are within the spirit and scope of the present invention.

What is claimed:

1. A food smoker comprising:
a housing comprising a base and a lid, wherein said lid is positioned on a top of said base;
a heat source disposed within said housing;
a ceramic chip bowl disposed above said heat source and below said lid; and
a first food rack comprising a cooking surface, wherein said first food rack is disposed between said ceramic chip bowl and said lid,
wherein said lid comprises a perimeter and a region within said perimeter, wherein said lid comprises a plurality of downward pointing protrusions positioned within said region within said perimeter and over said cooking surface, wherein each protrusion of said plurality of downward pointing protrusions is configured to provide a location for the concentration of condensate.

2. The food smoker of claim 1, wherein said base of said housing comprises a side wall, wherein said side wall comprises an inner side wall and an outer side wall, wherein said inner side wall and said outer side wall are separated by a side wall insulating gap, wherein said lid comprises an inner lid wall and an outer lid wall, wherein said inner lid wall and said outer lid wall are separated by a lid wall insulating gap.

3. The food smoker of claim 1, wherein said plurality of downward pointing protrusions comprises at least twelve protrusions.

4. The food smoker of claim 1, wherein each protrusion of said plurality of downward pointing protrusions is formed integrally with said lid.

5. The food smoker of claim 4, wherein said region within said perimeter of said lid is substantially planar except for said plurality of downward pointing protrusions, wherein said plurality of downward pointing protrusions are formed by deforming said lid in a downward direction from said region within said perimeter of said lid.

6. The food smoker of claim 5, wherein a first portion of said plurality of downward pointing protrusions are distributed in a first circular pattern on said lid, wherein said first circular pattern is centered at a center point of said lid, wherein said first circular pattern is disposed at a first distance form said center point, wherein a second portion of said plurality of downward pointing protrusions are distributed in a second circular pattern on said lid, wherein said second circular pattern is centered at said center point of said lid, wherein said second circular pattern is disposed at a second distance form said center point, wherein said first distance is less than said second distance.

7. The food smoker of claim 1, further comprising a water bowl disposed between said ceramic chip bowl and said first food rack.

8. The food smoker of claim 7, further comprising a diffuser disposed between said ceramic chip bowl and said water bowl.

9. The food smoker of claim 8, further comprising a second food rack disposed between said first food rack and said lid.

10. The food smoker of claim 1, wherein said heat source is a propane burner.

11. The food smoker of claim 1, wherein said lid comprises a first portion and a second portion, wherein said first portion is generally planar, wherein said second portion comprises said plurality of downward pointing protrusions, wherein said first and second portions are fastened to each other.

12. The food smoker of claim 11, wherein said first and second portions are removably and replaceably fastened to each other.

13. The food smoker of claim 1, wherein said ceramic chip bowl comprises a bottom wall and a side wall forming an interior portion, wherein said interior portion is uncovered by any portion of said ceramic chip bowl.

14. The food smoker of claim 1, wherein a composition of said ceramic chip bowl comprises silicon dioxide and aluminum oxide.

15. The food smoker of claim 14, wherein said composition of said ceramic chip bowl contains between 1.25 and 1.75 times more silicon dioxide than aluminum oxide.

16. The food smoker of claim 15, wherein between 50 and 60 percent of said composition of said ceramic chip bowl is silicon dioxide.

17. The food smoker of claim 16, wherein between 34 and 42 percent of said composition of said ceramic chip bowl is aluminum oxide.

18. The food smoker of claim 1, further comprising:
a food temperature access hole disposed through said housing proximate to said first food rack, and
a food temperature access hole cover positionable in a first position and a second position, wherein in said first position said food temperature access hole cover covers said food temperature access hole, wherein in said second position said food temperature access hole cover is not disposed over said food temperature access hole.

19. A method of smoking food, said method comprising:
inserting wood chips into a ceramic chip bowl;
positioning said ceramic chip bowl in a housing of a food smoker;
positioning food on a food rack within said housing above said ceramic chip bowl;
placing a lid on top of said housing;
producing heat within said housing, wherein said heat causes said wood chips to produce smoke;
condensing liquid on an underside of said lid of said food smoker to produce a condensate;
collecting said condensate at a lowermost portion of each protrusion of said plurality of protrusions; and
dripping said collected condensation from said plurality of protrusions onto said food.

20. The method of claim 19, further comprising:
placing water in a water bowl; and
placing said water bowl within said housing.
